(19) United States
(12) Patent Application Publication
(10) Pub. No.: US 2025/0350110 A1
(43) Pub. Date: Nov. 13, 2025

(54) STORAGE SYSTEM CONFIGURED FOR USE WITH AN ENERGY MANAGEMENT SYSTEM

(71) Applicant: Enphase Energy, Inc., Petaluma, CA (US)

(72) Inventors: Vamshi Krishna MIRYALA, Nalgonda (IN); Sivanageswararao UDDANTI, Bangalore (IN); Hitesh CHANDRAKAR, Bangalore (IN); Sambeet PANIGRAHI, Angul (IN); Robert Francis BROWN, Christchurch (NZ); Edward Owen BARNETT, Rangiora (NZ)

(21) Appl. No.: 19/199,920

(22) Filed: May 6, 2025

(30) Foreign Application Priority Data
May 10, 2024 (IN) 202411036891

(51) Int. Cl. H02H 7/122; H02H 1/00

(52) U.S. Cl. CPC H02H 7/122; H02H 1/0007

(57) ABSTRACT

A fault detection apparatus configured for use with a power converter in a storage system is provided herein and comprises an isolation circuit configured to connect to a DC side of the power converter that is configured to connect to a battery of the storage system, the isolation circuit comprising an isolation FET configured to automatically detect when a fault on the DC side of the power converter occurs and, when the fault is detected, the isolation FET is configured to automatically switch from a first state to a second state to isolate the power converter from other power converters that are connected to the battery.

### CROSS-REFERENCE TO RELATED APPLICATIONS

The present application claims the benefit of and priority to Indian Provisional Application Serial No. 20/241,1036891, filed on May 10, 2024, the entire contents of which is incorporated herein by reference.

### BACKGROUND

### Field of the Disclosure

Embodiments of the present disclosure generally relate to power systems and, for example, to methods and apparatus for DC isolation for storage systems in microinverter architecture.

### Description of the Related Art

Conventional storage systems comprise one or more batteries that can be coupled to one or more microinverters. For example, in some instances, the storage system (battery system) can comprise a battery that is connected to one or more microinverters (power converters). One or more apparatus configured to detect a fault (e.g., short, faulty power control unit (PCU), etc.) can be connected to the battery and/or the microinverter. For example, fuses, which are low cost, can be used to detect a fault, but cannot reliably isolate a faulty PCU at all conditions. Similarly, electronic switch based protection can be used and provide a reliable alternative to isolate faults at all conditions, but protection, typically, require costly driving and sensing circuits.

Therefore, the inventors have provided herein improved methods and apparatus for DC isolation for storage systems in microinverter architecture.

### SUMMARY

In accordance with some aspects of the present disclosure, a fault detection apparatus configured for use with a power converter in a storage system comprises an isolation circuit configured to connect to a DC side of the power converter that is configured to connect to a battery of the storage system, the isolation circuit comprising an isolation FET configured to automatically detect when a fault on the DC side of the power converter occurs and, when the fault is detected, the isolation FET is configured to automatically switch from a first state to a second state to isolate the power converter from other power converters that are connected to the battery.

In accordance with some aspects of the present disclosure, a storage system comprises a battery, a battery management unit configured to communicate with a system controller of an energy management system and configured to perform balancing of the battery, a power converter configured to communicate with the system controller and configured to convert DC power from a DC power source and discharge the battery to grid-compliant AC power, and a fault detection apparatus comprising an isolation circuit configured to connect to a DC side of the power converter and comprising an isolation FET configured to automatically detect when a fault on the DC side of the power converter occurs and, when the fault is detected, the isolation FET is configured to automatically switch from a first state to a second state to isolate the power converter from other power converters that are connected to the battery.

Various advantages, aspects, and novel features of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only a typical embodiment of this disclosure and are therefore not to be considered limiting of its scope, for the disclosure may admit to other equally effective embodiments.

FIG. 1 is a block diagram of a system for power conversion, in accordance with at least some embodiments of the present disclosure;

FIG. 2 is a block diagram of an AC battery system, in accordance with at least some embodiments of the present disclosure;

FIG. 3 is a schematic diagram of an apparatus configured for use with the AC battery system of FIG. 2, in accordance with at least one embodiment of the present disclosure;

FIG. 4 is a schematic diagram of an apparatus configured for use with the AC battery system of FIG. 2, in accordance with at least one embodiment of the present disclosure;

FIG. 5 is a diagram of isolation circuit operation during a short circuit fault in microinverter, in accordance with at least one embodiment of the present disclosure; and

FIG. 6 is a diagram of isolation circuit operation during startup, in accordance with at least one embodiment of the present disclosure.

### DETAILED DESCRIPTION

In accordance with the present disclosure, provided herein are improved methods and apparatus for DC isolation for storage systems in microinverter architecture. For example, a fault detection apparatus configured for use with a power converter in a storage system can comprise an isolation circuit configured to connect to a DC side of the power converter that is configured to connect to a battery of the storage system. The isolation circuit comprises an isolation FET configured to automatically detect when a fault on the DC side of the power converter occurs and, when the fault is detected, the isolation FET is configured to automatically switch from a first state to a second state to isolate the power converter from other power converters that are connected to the battery. The methods and apparatus described provide an intelligent, cost effective isolation system without using costly driving circuitry and can reduce the cost of full storage system without compromising performance of the storage system.

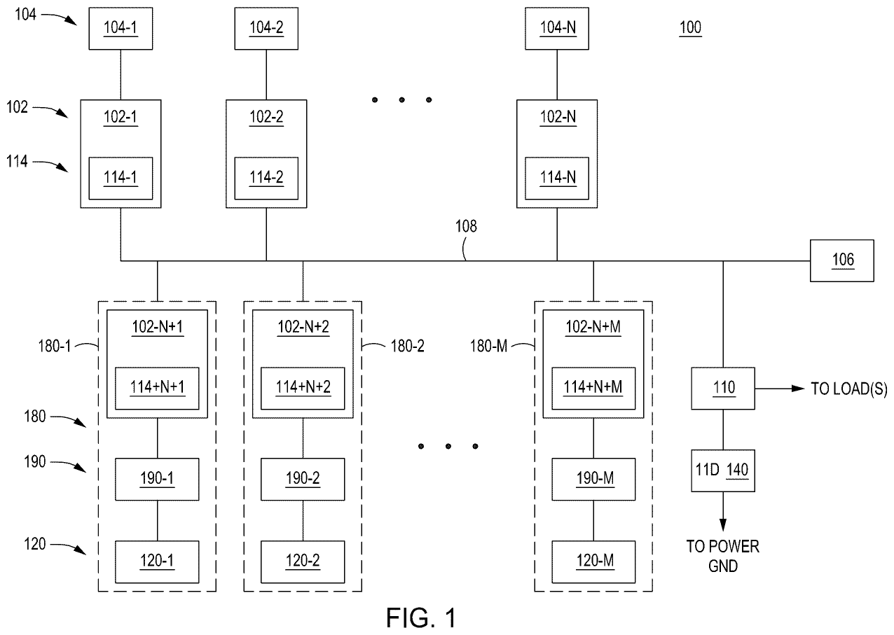

FIG. 1 is a block diagram of a system 100 (energy management system) for power conversion using one or more embodiments of the present disclosure. This diagram only portrays one variation of the myriad of possible system configurations and devices that may utilize the present disclosure.

The system 100 is a microgrid that can operate in both an islanded state and in a grid-connected state (i.e., when connected to another power grid (such as one or more other microgrids and/or a commercial power grid). The system 100 comprises a plurality of power converters 102-1, 102-2, . . . 102-N, 102-N+1, and 102-N+M collectively referred to as power converters 102 (which also may be called power conditioners); a plurality of DC power sources 104-1, 104-2, . . . 104-N, collectively referred to as power sources 104 (e.g., resources); a plurality of energy storage devices/delivery devices 120-1, 120-2, . . . 120-M collectively referred to as energy storage/delivery devices 120; a system controller 106; a plurality of BMUs 190-1, 190-2, . . . 190-M (battery management units) collectively referred to as BMUs 190; a system controller 106; a bus 108; a load center 110; and an IID 140 (island interconnect device) (which may also be referred to as a microgrid interconnect device (MID)). In some embodiments, such as the embodiments described herein, the energy storage/delivery devices are rechargeable batteries (e.g., multi-C-rate collection of AC batteries) which may be referred to as batteries 120, although in other embodiments the energy storage/delivery devices may be any other suitable device for storing energy and providing the stored energy. Generally, each of the batteries 120 comprises a plurality cells that are coupled in series, e.g., eight cells coupled in series to form a battery 120.

Each power converter 102-1, 102-2 . . . 102-N is coupled to a DC power source 104-1, 104-2 . . . 104-N, respectively, in a one-to-one correspondence, although in some other embodiments multiple DC power sources may be coupled to one or more of the power converters 102. The power converters 102-N+1, 102-N+2 . . . 102-N+M are respectively coupled to plurality of energy storage devices/delivery devices 120-1, 120-2 . . . 120-M via BMUs 190-1, 190-2 . . . 190-M to form AC batteries 180-1, 180-2 . . . 180-M, respectively. Each of the power converters 102-1, 102-2 . . . 102-N+M comprises a corresponding controller 114-1, 114-2 . . . 114-N+M (collectively referred to as the inverter controllers 114) for controlling operation of the power converters 102-1, 102-2 . . . 102-N+M.

In some embodiments, such as the embodiment described below, the DC power sources 104 are DC power sources and the power converters 102 are bidirectional inverters such that the power converters 102-1 . . . 102-N convert DC power from the DC power sources 104 to grid-compliant AC power that is coupled to the bus 108, and the power converters 102-N+1 . . . 102-N+M convert (during energy storage device discharge) DC power from the batteries 120 to grid-compliant AC power that is coupled to the bus 108 and also convert (during energy storage device charging) AC power from the bus 108 to DC output that is stored in the batteries 120 for subsequent use. The DC power sources 104 may be any suitable DC source, such as an output from a previous power conversion stage, a battery, a renewable energy source (e.g., a solar panel or photovoltaic (PV) module, a wind turbine, a hydroelectric system, or similar renewable energy source), or the like, for providing DC power. In other embodiments the power converters 102 may be other types of converters (such as DC-DC converters), and the bus 108 is a DC power bus.

The power converters 102 are coupled to the system controller 106 via the bus 108 (which also may be referred to as an AC line or a grid). The system controller 106 generally comprises a CPU coupled to each of support circuits and a memory that comprises a system control module for controlling some operational aspects of the system 100 and/or monitoring the system 100 (e.g., issuing certain command and control instructions to one or more of the power converters 102, collecting data related to the performance of the power converters 102, and the like). The system controller 106 is capable of communicating with the power converters 102 by wireless and/or wired communication (e.g., power line communication) for providing certain operative control and/or monitoring of the power converters 102.

In some embodiments, the system controller 106 may be a gateway that receives data (e.g., performance data) from the power converters 102 and communicates (e.g., via the Internet) the data and/or other information to a remote device or system, such as a master controller (not shown). Additionally or alternatively, the gateway may receive information from a remote device or system (not shown) and may communicate the information to the power converters 102 and/or use the information to generate control commands that are issued to the power converters 102.

The power converters 102 are coupled to the load center 110 via the bus 108, and the load center 110 is coupled to the power grid via the IID 140. When coupled to the power grid (e.g., a commercial grid or a larger microgrid) via the IID 140, the system 100 may be referred to as grid-connected; when disconnected from the power grid via the IID 140, the system 100 may be referred to as islanded. The IID 140 determines when to disconnect from/connect to the power grid (e.g., the IID 140 may detect a grid fluctuation, disturbance, outage or the like) and performs the disconnection/connection. Once disconnected from the power grid, the system 100 can continue to generate power as an intentional island, without imposing safety risks on any line workers that may be working on the grid, using the droop control techniques described herein. The IID 140 comprises a disconnect component (e.g., a disconnect relay) for physically disconnecting/connecting the system 100 from/to the power grid. In some embodiments, the IID 140 may additionally comprise an autoformer for coupling the system 100 to a split-phase load that may have a misbalance in it with some neutral current. In certain embodiments, the system controller 106 comprises the IID 140 or a portion of the IID 140.

The power converters 102 convert the DC power from the DC power sources 104 and discharge the batteries 120 to grid-compliant AC power and couple the generated output power to the load center 110 via the bus 108. The power is then distributed to one or more loads (for example to one or more appliances) and/or to the power grid (when connected to the power grid). Additionally or alternatively, the generated energy may be stored for later use, for example using batteries, heated water, hydro pumping, H₂O-to-hydrogen conversion, or the like. Generally, the system 100 is coupled to the commercial power grid, although in some embodiments the system 100 is completely separate from the commercial grid and operates as an independent microgrid.

In some embodiments, the AC power generated by the power converters 102 is single-phase AC power. In other embodiments, the power converters 102 generate three-phase AC power.

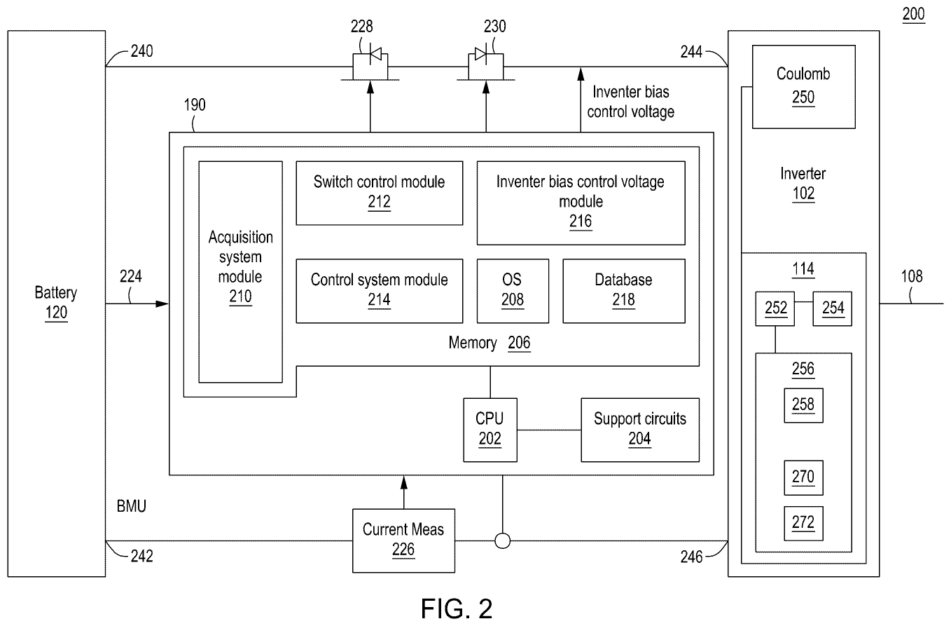

A storage system configured for use with an energy management system, such as the Enphase® Energy System, is described herein. For example, FIG. 2 is a block diagram of an AC battery system 200 (e.g., a storage system) in accordance with one or more embodiments of the present disclosure.

The AC battery system 200 comprises a BMU 190 coupled to a battery (e.g., the battery 120) and one or more inverters (e.g., the power converters 102). In at least some embodiments, the battery 120 can comprise a plurality of cells (not shown) and the power converters 102 can comprise four embedded converters (e.g., four embedded microinverters). In at least some embodiments, the battery 120 can be the IQ Battery 3 (or the IQ Battery 10) and the microinverters can be the IQ8X-BAT microinverters, both available from Enphase®. A pair of metal-oxide-semiconductor field-effect transistors (MOSFETs) switches—switches 228 and 230—are coupled in series between a first terminal 240 of the battery 120 and a first terminal of the inverter 144 such the body diode cathode terminal of the switch 228 is coupled to the first terminal 240 of the battery 120 and the body diode cathode terminal of the switch 230 is coupled to the first terminal 244 of the power converter 102. The gate terminals of the switches 228 and 230 are coupled to the BMU 190.

A second terminal 242 of the battery 120 is coupled to a second terminal 246 of the power converter 102 via a current measurement module 226 which measures the current flowing between the battery 120 and the power converter 102.

The BMU 190 is coupled to the current measurement module 226 for receiving information on the measured current, and also receives an input 224 from the battery 120 indicating the battery cell voltage and temperature. The BMU 190 is coupled to the gate terminals of each of the switches 228 and 230 for driving the switch 228 to control battery discharge and driving the switch 230 to control battery charge as described herein. The BMU 190 is also coupled across the first terminal 244 and the second terminal 246 for providing an inverter bias control voltage (which may also be referred to as a bias control voltage) to the inverter 102 as described further below.

The configuration of the body diodes of the switches 228 and 230 allows current to be blocked in one direction but not the other depending on state of each of the switches 228 and 230. When the switch 228 is active (i.e., on) while the switch 230 is inactive (i.e., off), battery discharge is enabled to allow current to flow from the battery 120 to the power converter 102 through the body diode of the switch 230. When the switch 228 is inactive while the switch 230 is active, battery charge is enabled to allow current flow from the power converter 102 to the battery 120 through the body diode of the switch 228. When both switches 228 and 230 are active, the system is in a normal mode where the battery 120 can be charged or discharged.

The BMU 190 comprises support circuits 204 and a memory 206 (e.g., non-transitory computer readable storage medium), each coupled to a CPU 202 (central processing unit). The CPU 202 may comprise one or more processors, microprocessors, microcontrollers and combinations thereof configured to execute non-transient software instructions to perform various tasks in accordance with embodiments of the present disclosure. The CPU 202 may additionally or alternatively include one or more application specific integrated circuits (ASICs). In some embodiments, the CPU 202 may be a microcontroller comprising internal memory for storing controller firmware that, when executed, provides the controller functionality described herein. The BMU 190 may be implemented using a general purpose computer that, when executing particular software, becomes a specific purpose computer for performing various embodiments of the present disclosure.

The support circuits 204 are well known circuits used to promote functionality of the CPU 202. Such circuits include, but are not limited to, a cache, power supplies, clock circuits, buses, input/output (I/O) circuits, and the like. The BMU 190 may be implemented using a general purpose computer that, when executing particular software, becomes a specific purpose computer for performing various embodiments of the present disclosure. In one or more embodiments, the CPU 202 may be a microcontroller comprising internal memory for storing controller firmware that, when executed, provides the controller functionality described herein.

The memory 206 may comprise random access memory, read only memory, removable disk memory, flash memory, and various combinations of these types of memory. The memory 206 is sometimes referred to as main memory and may, in part, be used as cache memory or buffer memory. The memory 206 generally stores the OS 208 (operating system), if necessary, of the inverter controller 114 that can be supported by the CPU capabilities. In some embodiments, the OS 208 may be one of a number of commercially available operating systems such as, but not limited to, LINUX, Real-Time Operating System (RTOS), and the like.

The memory 206 stores non-transient processor-executable instructions and/or data that may be executed by and/or used by the CPU 202 to perform, for example, one or more methods for discharge protection, as described in greater detail below. These processor-executable instructions may comprise firmware, software, and the like, or some combination thereof. The memory 206 stores various forms of application software, such as an acquisition system module 210, a switch control module 212, a control system module 214, and an inverter bias control module 216. The memory 206 additionally stores a database 218 for storing data related to the operation of the BMU 190 and/or the present disclosure, such as one or more thresholds, equations, formulas, curves, and/or algorithms for the control techniques described herein. In various embodiments, one or more of the acquisition system module 210, the switch control module 212, the control system module 214, the inverter bias control module 216, and the database 218, or portions thereof, are implemented in software, firmware, hardware, or a combination thereof.

The acquisition system module 210 obtains the cell voltage and temperature information from the battery 120 via the input 224, obtains the current measurements provided by the current measurement module 226, and provides the cell voltage, cell temperature, and measured current information to the control system module 214 for use as described herein.

The switch control module 212 drives the switches 228 and 230 as determined by the control system module 214. The control system module 214 provides various battery management functions, including protection functions (e.g., overcurrent (OC) protection, overtemperature (OT) protection, and hardware fault protection), metrology functions (e.g., averaging measured battery cell voltage and battery current over, for example, 100 ms to reject 50 and 60 Hz ripple), state of charge (SoC) analysis (e.g., coulomb gauge 250 for determining current flow and utilizing the current flow in estimating the battery SoC; synchronizing estimated SOC values to battery voltages (such as setting SoC to an upper bound, such as 100%, at maximum battery voltage; setting SoC to a lower bound, such as 0%, at a minimum battery voltage); turning off SoC if the power converter 102 never drives the battery 120 to these limits; and the like), balancing (e.g., autonomously balancing the charge across all cells of a battery to be equal, which may be done at the end of charge, at the end of discharge, or in some embodiments both at the end of charge and the end of discharge). By establishing upper and lower estimated SoC bounds based on battery end of charge and end of discharge, respectively, and tracking the current flow and cell voltage (i.e., battery voltage) between these events, the BMU 190 determines the estimated SoC.

Continuing with reference to FIG. 2, the inverter controller 114 comprises support circuits 254 and a memory 256, each coupled to a CPU 252 (central processing unit). The CPU 252 may comprise one or more processors, microprocessors, microcontrollers and combinations thereof configured to execute non-transient software instructions to perform various tasks in accordance with embodiments of the present disclosure. The CPU 252 may additionally or alternatively include one or more application specific integrated circuits (ASICs). In some embodiments, the CPU 252 may be a microcontroller comprising internal memory for storing controller firmware that, when executed, provides the controller functionality herein. The inverter controller 114 may be implemented using a general purpose computer that, when executing particular software, becomes a specific purpose computer for performing various embodiments of the present disclosure.

The support circuits 254 are well known circuits used to promote functionality of the CPU 252. Such circuits include, but are not limited to, a cache, power supplies, clock circuits, buses, input/output (I/O) circuits, and the like. The inverter controller 114 may be implemented using a general purpose computer that, when executing particular software, becomes a specific purpose computer for performing various embodiments of the present disclosure. In one or more embodiments, the CPU 252 may be a microcontroller comprising internal memory for storing controller firmware that, when executed, provides the controller functionality described herein.

The memory 256 may comprise random access memory, read only memory, removable disk memory, flash memory, and various combinations of these types of memory. The memory 256 is sometimes referred to as main memory and may, in part, be used as cache memory or buffer memory. The memory 256 generally stores the OS 258 (operating system), if necessary, of the inverter controller 114 that can be supported by the CPU capabilities. In some embodiments, the OS 258 may be one of a number of commercially available operating systems such as, but not limited to, LINUX, Real-Time Operating System (RTOS), and the like.

The memory 256 stores non-transient processor-executable instructions and/or data that may be executed by and/or used by the CPU 252. These processor-executable instructions may comprise firmware, software, and the like, or some combination thereof. The memory 256 stores various forms of application software, such as a power conversion control module 270 for controlling the bidirectional power conversion, and a battery management control module 272.

The BMU 190 communicates with the system controller 106 to perform balancing of the batteries 120 (e.g., multi-C-rate collection of AC batteries) based on a time remaining before each of the batteries are depleted of charge, to perform droop control (semi-passive) which allows the batteries to run out of charge at substantially the same time, and perform control of the batteries to charge batteries having less time remaining before depletion using batteries having more time remaining before depletion, as described in greater detail below.

As noted above, the inventors provide herein improved methods and apparatus for DC isolation for storage systems in microinverter architecture. For example, the isolation circuits can be configured for use with microinverters connected in parallel to a central DC storage system and can provide fault redundancy with proper DC isolation. With respect to PCU isolation, the isolation circuits described herein provide low-cost solutions as the isolation circuits do not require any external current sensing for fault event detection. And, when compared to conventional sensor-less fault detection methods, such as on-state drop based fault detection techniques, the methods described herein have quicker and more reliable response to all fault conditions.

The isolation circuit uses a novel sensing circuit that combines V_{ds} drop sensing with a gate voltage modulation technique to reliably detect & isolate a fault event. The gate voltage modulation technique uses a voltage drop across a di/dt sense inductor and a drop in the input DC bus bulk capacitance. Thus, the fault detection circuit can detect a short circuit fault even when di/dt sense inductor is saturated. The signal sensing can be achieved using unique circuit configuration that only uses passive elements and can be implemented at a relatively low-cost. Additionally, the isolation circuit senses switching frequency current component that flows through the DC side of the converter, which can be beneficial in detecting a HF transformer saturation event in DC-DC and DC-AC converters that use a transformer to provide isolation. Thus, the isolation circuit can detect a fault event in most of the corner conditions at relatively low cost and can also provide additional sensing capabilities that can be beneficial to converter control during normal operation.

The self-driven isolation circuit senses and combines multiple feedback signals to detect a fault event. In at least some embodiments, the signals can comprise (i) Drain to source voltage (V_{ds}) across a Series FET, (ii) di/dt of fault current, and (iii) sharp voltage drop in a DC bus bulk capacitance during fault event. For example, the V_{ds} sensing is combined with a novel di/dt based V_{gs} modulation technique to quickly detect the fault event. In addition, the inductor used to sense the di/dt in the isolation circuit can also be used for deriving other useful signals, such as shoot through event detection and sensing DC bridge switching frequency component current. Additionally, since the isolation circuit is configured at transistor level using low-cost components only, the isolation circuit does not require any costly components. Moreover, a power converter uses a novel faulty PCU detection method that will ensure that a Series-FET of the faulty PCU never turns on.

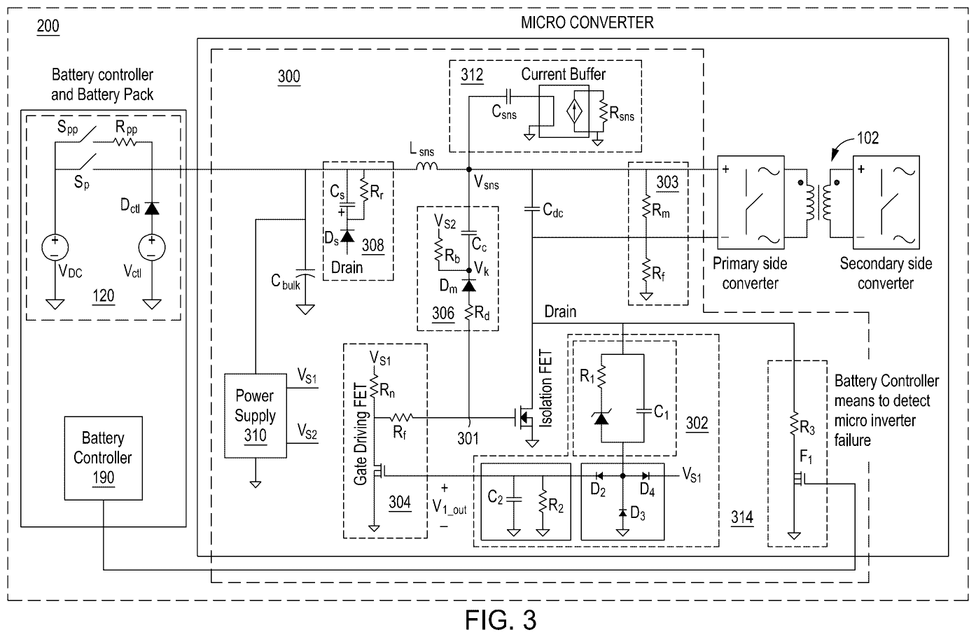

For example, FIG. 3 is a schematic diagram of an apparatus configured for use with the AC battery system of FIG. 2, in accordance with at least one embodiment of the present disclosure. For example, an isolation circuit 300 can comprise a V_{ds} sensing circuit 302, an impedance measurement circuit 303, a gate driving circuit 304, a modulation circuit 306, a snubber circuit 308, a power supply 310, a current buffer circuit 312, and a forward on logic 314.

Continuing with reference to FIG. 3, for V_{ds} sensing a FET latching logic can be implemented using an isolation FET 301 that is coupled to the V_{ds} sensing circuit 302 which comprises blocks 11, 12, and 13. Block 11 injects two components of currents, which are (i) a first current component that is proportional to dv/dt of V_{ds} voltage (current through C1) and (ii) a second current component that is proportional to V_{ds} voltage and is only injected when V_{ds} voltage is greater than a certain threshold (e.g., a threshold set by Zener diode Z1). The output current of block 11 is rectified by diodes in block 12 diodes (D₂-D₄). In addition, the block 12 also clamps maximum and minimum voltage to set levels (Vₛ₁ volts, 0V). The output current of block 12 is a rectified DC current in nature which is converted again into voltage signal using an RC impedance circuit present in block 13. The V_{ds} sensing circuit 302 is configured to sense voltage across an isolation FET 301 to detect a fault event and isolate the isolation FET 301. For example, the V_{ds} sensing circuit 302 can be configured to sense a rise in an ON-state voltage drop. When the rise crosses a particular threshold, the isolation FET 301 can be turned OFF. For example, the V_{ds} sensing circuit 302 can be configured to sense a DC component of the isolation FET 301 drain to source (V_{ds}) voltage, which facilitates latching the isolation FET 301 into an OFF state. In at least some embodiments, the V_{ds} sensing circuit 302 and the forward on logic 314 can be configured to determine a fault state of a microinverter at a time of startup. The V_{ds} sensing circuit 302 can be configured to limit voltage output to a safe value and ensure positive sense output voltage V_{S1} at the time of turn-off ringing duration, which can cause significant ripple in a sensed voltage and can lead to un-intended operation. The V_{ds} sensing circuit 302 is designed to rectify the ringing and ensure a high signal during the time of turn-off ringing duration as well.

The gate driving circuit 304 (which comprises a gate driving FET F₂) is connected to the gate of the isolation FET 301 and to the V_{ds} sensing circuit 302. The gate driving circuit is configured to drive the gate of the isolation FET 301. For example, the gate driving circuit 304 is configured as a gate driver to the isolation FET 301 and comprises a resistor Rₙ (e.g., a relatively large resistor) that is configured to keep the isolation FET 301 in a normally ON state. For example, a supply voltage (e.g., sense output voltage V_{S1}) decides ON state gate voltage, and when the gate voltage of the FET F₁ crosses the threshold voltage of the gate driving FET F₂, the gate driving FET F₂ turns ON and pulls the gate voltage of the isolation FET 301 to about 0V. Once the isolation FET 301 turns-off, the isolation FET 301 blocks full DC voltage across the isolation FET 301, so the V_{ds} sensing circuit 302 conducts and holds the gate voltage of the FET F₁ to V_{S1} value, which keeps the gate driving FET F₂ in ON-state and latches the isolation FET 301 in the OFF state. Thus, latching the isolation FET 301 is achieved using pure discrete components. The resistor R_{f} is configured as a turn-off gate resistance and is used to control the speed of a turn-off transient.

In at least some embodiments, the isolation circuit 300 can use one or more inductors (not shown) in the PCU to sense di/dt of the fault current event. For example, a relatively large di/dt drop across inductor Lₛₙₛ can be AC coupled to the gate of the isolation FET 301 to pull the gate voltage low. In at least some embodiments, the snubber circuit (5) can be configured to limit voltage overshoot.

The modulation circuit 306 is configured to modulate the gate to source voltage of the isolation FET 301 using, for example, di/dt drop appearing across the inductor Lₛₙₛ and voltage drop appearing across the capacitor C_{DC} at the event of fault condition. Additionally, a capacitor C_{c} AC-couples the voltage to the gate of the isolation FET 301. A resistor R_{b} (a relatively large resistor) is configured to DC bias a cathode of a diode Dₘ at a Vₛ₂ voltage level. In at least some embodiments, a supply Level Vₛ₂ can be selected to be greater than or equal to sense output voltage V_{S1}, such that the diode Dₘ remains in OFF state in normal operation. A supply Level Vₛ₂ that is selected to be greater than or equal to sense output voltage V_{S2} also provides appropriate noise margins for the isolation circuit 300. At the event of fault, the voltage at the Lₛₙₛ node drops, which turns on the Diode D_{M} and allows the gate voltage of the isolation FET 301 to discharge. As fault current rises and gate voltage is falling simultaneously in the isolation FET 301, the isolation FET 301 V_{ds} voltage begins to rise quickly. The increase in V_{ds} voltage is detected by the V_{ds} sensing circuit 302 and gate driving circuit 304, and the V_{ds} sensing circuit 302 and gate driving circuit 304 quickly initiate the turn-off of the isolation FET 31. Thus, the modulation circuit 306 (e.g., gate voltage modulation technique) assists the V_{ds} sensing circuit 302 and the gate driving circuit 304 (e.g., gate driving) to quickly turn-off the isolation FET 301. The di/dt based gate modulation technique provides fast detection of fault and reliable turn-off. Additionally, the unique placement of di/dt sense inductor allows Lₛₙₛ for filter, fault detection and fault isolation.

An impedance measurement circuit 303 (e.g., a microinverter impedance measurement circuit) is configured to connect to a battery (e.g., a battery pack) and battery controller (e.g., the battery 120 and the BMU 190) such that the power converter is powered through a control supply voltage of the battery, and a resistor divider of the impedance measurement circuit divides the control supply voltage into an appropriate ratio. For example, one or more switches (e.g., the switches Sₚ and Sₚₚ which can correspond to switches 228 and 230) of the battery 120 and/or the BMU 190 are configured to remain in open circuit condition, and the micro converters (e.g., the power converters 102) are powered through a control supply of the battery controller V_{ctl}. Thus, if a microinverter is healthy and has large impedance at the time of power-up, the resistor divider (e.g., Rₘ (effective impedance of the inverter), R_{f}) divides the voltage V_{ctl} into an appropriate ratio. But if the microinverter is faulty (e.g., short circuited), then the isolation FET 301 only blocks the entire V_{ctl} voltage at the startup. The Vds sensing circuit 302 and the forward on logic 314 can be tuned to manipulate such an operation and turn-on the isolation FET 301 only if the microinverter is healthy. Otherwise, the isolation FET 301 remains in the OFF state and gets latched in the OFF state when the one or more switches of the battery 120 and the BMU 190 are turned ON.

The snubber circuit 308 is configured to limit a turn-off voltage overshoot by redirecting the energy stored in the inductor Lₛₙₛ into the capacitor Cₛ. The diode Dₛ disconnects the capacitor Cₛ during normal operation, and the resistor Rᵣ maintains the initial voltage across the Cₛ at 0V.

The power supply 310 is configured to supply voltages Vₛ₁ and Vₛ₂ to generate a relatively small power requirement. In at least some embodiments, a resistor-Zener diode supply can be used to power-up Vₛ₁ and Vₛ₂ supplies.

The current buffer circuit 312 is configured to sense a current flowing through the capacitor C_{dc}. The current flowing through the capacitor C_{dc} can be sensed by adding a small capacitance (Cₛₙₛ) in parallel to C_{dc}. The current buffer circuit 312 can be used to avoid any loading effects on the sense output voltage V_{S1}. The current information can be used to detect transformer saturation conditions to improve controller behavior and can also be added with actual DC current sensed by the controller IC of the microinverter to implement controls such as peak current mode controller.

If a battery controller (e.g., the BMU 190) detects that isolation FET 301 is lached in an OFF state and not sure whether the inverter is actually faulty, the forward on logic 314 provides a way to confirm whether the inverter is actually faulty or not, e.g., by checking if transistor F₁ is turned ON. In the instance of healthy inverter, the resistor R₃ pulls the V_{ds} voltage of the isolation FET 301 to a low enough voltage such that turn-off latching of the isolation FET 301 is disabled, which would turn-on the isolation FET 301 and enable the power conversion. If the inverter is faulty (e.g., failed short) then the resistor R₃ will not be able to pull down the V_{ds} voltage of the isolation FET 301, and the faulty inverter remains in OFF state.

Once the isolation FET 301 turns off after detecting a faulty inverter, the V_{ds} sensing section continues to take a small amount of power loss through the resistor R₁, which may not be desirable for battery products. Thus, in the absence of a switch in series with the battery pack, the small amount of current can deplete the energy in the battery and can lead to deep discharge of the battery. To avoid such an occurrence, a cascode connection based Isolation FET can be optionally used.

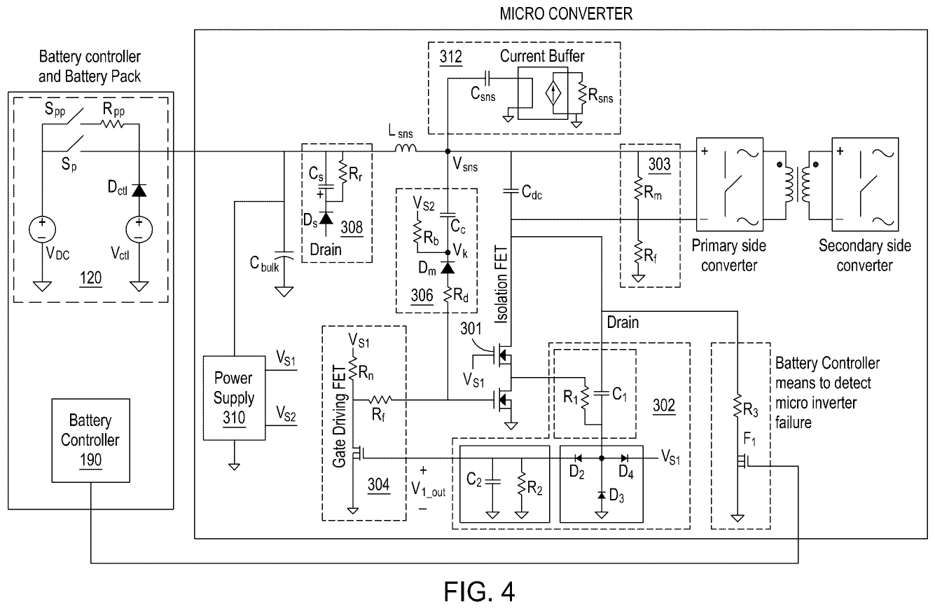

For example, FIG. 4 is a schematic diagram of an apparatus configured for use with the AC battery system of FIG. 2, in accordance with at least one embodiment of the present disclosure. For example, in at least some embodiments, instead of using a single the isolation FET, two isolation FETS in cascode configuration can be used. In such embodiments, the cascode configuration is configured to reduce power dissipation in OFF state, which is required for longer storage time.

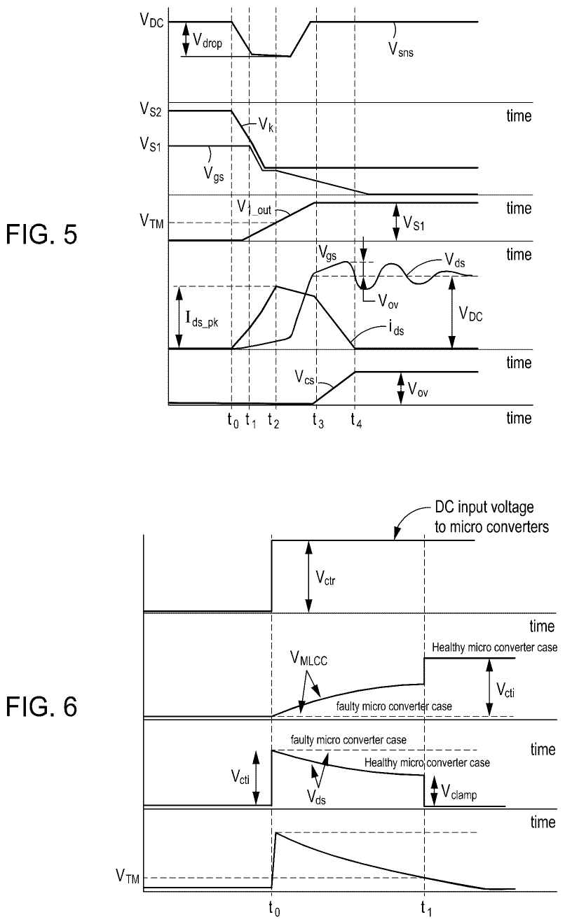

FIG. 5 is a diagram of isolation circuit (e.g., the isolation circuit 300) operation during a short circuit fault in microinverter, in accordance with at least one embodiment of the present disclosure. The isolation FET 301 is assumed closed and the microinverter (e.g., the power converter 102) is producing power. Additionally, the primary side of the power converter is assumed to be a failed short at time t₀.

The inventors note that before time t₀ the gate to source voltage of the isolation FET 301 (e.g., V_{gs}) is at Vₛ₁ level, so the isolation FET 301 is in a Fully ON state. Additionally, the cathode of the diode Dₘ is biased at a Vₛ₂ level. Thus, as Vₛ₂>=Vₛ₁, the Diode Dₘ is initially in an OFF state and output voltage of the forward on logic 314 (e.g., v1_out) is at 0V too.

Continuing with reference to FIG. 5, during time t₀-t₁ the primary side of the microinverter is a failed short at time t₀, which causes the current through the inductor Lₛₙₛ to increase and creates a di/dt drop across the inductor Lₛₙₛ. The voltage across the inductor Lₛₙₛ appears as a drop in the Vₛₙₛ node voltage. The drop in the Vₛₙₛ node voltage is AC coupled to the cathode of diode Dₘ, and thus the cathode voltage Dₘ (Vₖ) starts reducing too.

Next, during time t₁-t₂, at time t₁ the Vₖ voltage becomes equal to V_{gs} voltage of the isolation FET 301, and thereafter the diode Dₘ begins to conduct and V_{gs} voltage of the isolation FET 301 drops along with the Vₖ voltage, until the V_{gs} voltage of the isolation FET 301 reaches steady state voltage, e.g., V_{drop}. During time t₁, current (e.g., ids) through the isolation FET 301 also linearly increases. As reduction in V_{gs} voltage and increase in ids current of the isolation FET 301 cause the isolation FET 301 to de-saturate at much lower current value and leads to increase in V_{ds} voltage. The V_{ds} sensing circuit 302 (e.g., a V_{ds} sensing circuit output (V_{1_out})) increases with increase in V_{ds} voltage, which causes the gate driving FET F₂ (e.g., latching FET) to turn-on.

Next, during time t₂-t₃, turning on the latching FET starts discharging the gate of the isolation FET 301, which initiates the turn-off process for the isolation FET 301. For example, the discharging of the gate current of the isolation FET 301 causes V_{ds} voltage of the isolation FET 301 to increase, which continues until time t₃, where V_{ds} voltage becomes equal to V_{DC} (e.g., a battery voltage). The inventors note that the increase in V_{ds} causes V_{1_out} to further increase, and the V_{1_out} eventually gets clamped at Vₛ₁ voltage level due to the V_{ds} sensing circuit 302 (e.g., one or more clamping diodes that can be provided in the V_{ds} sensing circuit 302 present in block 12 shown in FIG. 3)

Next, during time t₃-t₄, once V_{ds} becomes equal to V_{DC} voltage, the snubber diode (e.g., Dₛ) in the snubber circuit 308 conducts and enables snubber capacitor (Cₛ) to operate. The snubber capacitor Cₛ stores the energy present in inductor Lₛₙₛ, thus limiting the voltage overshoot that would have occurred in the isolation FET 301 otherwise. After the completion of energy transfer, the capacitor Cₛ slowly discharges stored energy using resistor Rᵣ. The V_{DC} voltage across the V_{ds}, causes latch FET (e.g., the FET F₂) to remain in ON state until the power supply is recycled. Thus, successfully isolating the microinverter.

The inventors note that, even if the inductor Lₛₙₛ closes to the inductor Lₛₙₛ saturation limit, the isolation circuit 300 still operates as intended because of the ON state drop measurement circuit, but the isolation would occur at larger currents. The magnitude of the turn-off current, however, is still limited by the voltage drop experienced by the capacitor C_{bulk} during a fault event. The voltage drop in C_{bulk} occurs due to wire parasitic impedance present in the battery pack to microinverter path, which covers wider corner conditions and ensures reliability of the isolation FET 301.

FIG. 6 is a diagram of isolation circuit operation during startup, in accordance with at least one embodiment of the present disclosure. For example, at the start-up of microinverter system, knowing which, if any, of the microinverters are faulty is important. If so, an isolation FET of a faulty microinverter can be maintained in OFF state to avoid any unintended fault currents at the startup. In accordance with the present disclosure, the faulty micro converter inspection and driving the isolation FETs to appropriate state is automatically achieved without needing any external circuitry. The automatic isolation of faulty microinverters at startup is achieved by applying a DC input voltage that is within a specific range. When such voltage is applied, the isolation circuit starts in an inspection mode.

For example, when a battery controller (e.g., the BMU 190) is started, the battery controller starts with one or more switches (e.g., switch Sₚ and Sₚₚ, FIG. 3) in OFF state. So, a diode D_{ctl} conducts and applies V_{ctl} voltage to all the microinverters. The timing of power supplies of isolation circuit are designed in such a way that the isolation FET 301 starts in OFF state.

For example, continuing with reference to FIG. 6, at time t₀ V_{ctl} voltage is applied to all of the microinverters. As the isolation FET 301 is OFF and initial voltage across C_{bulk} is 0V, the entire V_{ctl}is blocked by the isolation FET 301 (e.g., V_{ds} voltage). The clamping voltage of the V_{ds} sensing circuit 302 (e.g., a Zener diode) is selected such that the latching FET (FET F₂) remains in ON state when V_{ds}=V_{ctl}.

In the case of a healthy microinverter, the Rₘ, R_{f} resistor divider slowly discharges V_{ds} voltage to a voltage level (V_{clamp}) such that the latching FET V_{gs} voltage becomes less than a threshold voltage (V_{TH}) as shown in t₁ instant of FIG. 6. When V_{gs} voltage becomes less than a threshold voltage (V_{TH}), the latching FET turns OFF and the isolation FET 301 turns-on. Once the isolation FET 31 turns ON, the latching FET V_{gs} becomes 0V and the Isolation FET 301 latches in the ON state.

Conversely, in the case of a faulty microinverter, the primary side of the power converter is short circuited. Thus, the resistors Rm, Rf are not able to discharge the V_{ds} voltage, as shown in faulty converter case of FIG. 6. Thus, the isolation FET 301 remains in the OFF state.

Once the Isolation FET latches in an appropriate state, the Switch Sₚₚ is closed to pre-charge the microinverters to a battery pack voltage. Then switch Sₚ is closed to enable power conversion.

While the foregoing is directed to embodiments of the present disclosure, other and further embodiments of the disclosure may be devised without departing from the basic scope thereof, and the scope thereof is determined by the claims that follow.

1. A fault detection apparatus configured for use with a power converter in a storage system, comprising:
an isolation circuit configured to connect to a DC side of the power converter that is configured to connect to a battery of the storage system, the isolation circuit comprising an isolation FET configured to automatically detect when a fault on the DC side of the power converter occurs and, when the fault is detected, the isolation FET is configured to automatically switch from a first state to a second state to isolate the power converter from other power converters that are connected to the battery.

2. The fault detection apparatus of claim 1, wherein the first state of the isolation FET is on and the second state of the isolation FET is off.

3. The fault detection apparatus of claim 1, wherein the first state of the isolation FET is off and the second state of the isolation FET is off.

4. The fault detection apparatus of claim 1, wherein the isolation circuit further comprises a gate driving circuit comprising a gate driving FET that is connected to a gate of the isolation FET and configured to latch the isolation FET in at least one of the first state or the second state.

5. The fault detection apparatus of claim 1, wherein the isolation circuit further comprises a modulation circuit that is configured to modulate a gate to source voltage of the isolation FET using a di/dt drop appearing across an inductor and a voltage drop appearing across a capacitor when the fault is detected.

6. The fault detection apparatus of claim 5, wherein the inductor and the capacitor are connected in parallel to each other and the isolation circuit.

7. The fault detection apparatus of claim 1, wherein the isolation circuit further comprises an impedance measurement circuit that is configured to connect to the battery such that the power converter is powered through a control supply voltage of the battery, and wherein a resistor divider of the impedance measurement circuit divides the control supply voltage into an appropriate ratio.

8. The fault detection apparatus of claim 1, wherein the isolation circuit further comprises a snubber circuit that is configured to limit a turn-off voltage overshoot by redirecting energy stored in an inductor connected in parallel with the snubber circuit into a capacitor of the snubber circuit.

9. The fault detection apparatus of claim 8, wherein the snubber circuit comprises a diode that is configured to disconnect the capacitor during normal operation and a resistor that is configured to maintain an initial voltage across the capacitor.

10. The fault detection apparatus of claim 1, wherein the isolation circuit further comprises a power supply that is configured to supply voltages to generate a relatively small power requirement for the isolation circuit to automatically detect when the fault on the DC side of the power converter occurs.

11. The fault detection apparatus of claim 10, wherein the power supply comprises a resistor-Zener diode supply that is configured to supply the voltages to generate the relatively small power requirement.

12. The fault detection apparatus of claim 1, wherein the isolation circuit further comprises a current buffer circuit that is configured to sense a current flowing through a first capacitor of the isolation circuit.

13. The fault detection apparatus of claim 12, wherein the current buffer circuit comprises a second capacitor that is connected in parallel with the first capacitor, and wherein the current buffer circuit is configured to avoid loading effects on an output voltage of a power supply of the isolation circuit.

14. A storage system, comprising:
a battery;
a battery management unit configured to communicate with a system controller of an energy management system and configured to perform balancing of the battery;
a power converter configured to communicate with the system controller and configured to convert DC power from a DC power source and discharge the battery to grid-compliant AC power; and
a fault detection apparatus comprising:
an isolation circuit configured to connect to a DC side of the power converter and comprising an isolation FET configured to automatically detect when a fault on the DC side of the power converter occurs and, when the fault is detected, the isolation FET is configured to automatically switch from a first state to a second state to isolate the power converter from other power converters that are connected to the battery.

15. The storage system of claim 14, wherein the first state of the isolation FET is on and the second state of the isolation FET is off.

16. The storage system of claim 14, wherein the first state of the isolation FET is off and the second state of the isolation FET is off.

17. The storage system of claim 14, wherein the isolation circuit further comprises a gate driving circuit comprising a gate driving FET that is connected to a gate of the isolation FET and configured to latch the isolation FET in at least one of the first state or the second state.

18. The storage system of claim 14, wherein the isolation circuit further comprises a modulation circuit that is configured to modulate a gate to source voltage of the isolation FET using a di/dt drop appearing across an inductor and a voltage drop appearing across a capacitor when the fault is detected.

19. The storage system of claim 18, wherein the inductor and the capacitor are connected in parallel to each other and the isolation circuit.

20. The storage system of claim 14, wherein the isolation circuit further comprises an impedance measurement circuit that is configured to connect to the battery such that the power converter is powered through a control supply voltage of the battery, and wherein a resistor divider of the impedance measurement circuit divides the control supply voltage into an appropriate ratio.
